(19) United States
(12) Patent Application Publication
(10) Pub. No.: US 2018/0300649 A1
(43) Pub. Date: Oct. 18, 2018

(54) SYSTEM AND METHOD FOR VERIFYING AND CORRECTING KNOWLEDGE BASE

(71) Applicant: SALTLUX INC., Seoul (KR)

(72) Inventors: Kyung I1 Lee, Seoul (KR); Young Kyoung Ham, Seoul (KR)

(73) Assignee: SALTLUX INC., Seoul (KR)

(21) Appl. No.: 15/738,112

(22) PCT Filed: Nov. 10, 2016
(86) PCT No.: PCT/KR2016/012923

§ 371 Date: Mar. 29, 2018

(30) Foreign Application Priority Data
Jan. 26, 2016 (KR) 10-2016-0009404

(51) Int. Cl. G06N 99/00; G06N 3/00

(52) U.S. Cl. CPC G06N 99/005; G06N 3/006

(57) ABSTRACT

A knowledge base correction system includes a question generator configured to detect incomplete knowledge data of a knowledge base, and to generate a question, an answer to which is used to correct the incomplete knowledge data; a user information storage configured to store level information about a plurality of users; and a question selector configured to determine a number of questions and questions to be assigned to each of the plurality of users, based on the level information of the plurality of users.

### TECHNICAL FIELD

The present invention relates to a system and method for verifying and correcting a knowledge base, and more particularly, to a system and method for detecting and correcting incomplete knowledge data.

The present invention is the result of a research study conducted by Saltlux, Inc. organized as part of Global Creative SW led by the Korean Ministry of Science, ICT and Future Planning, [Research Period: Mar. 1, 2016, to Feb. 29, 2016, Research Managing Professional Organization: Institute for Information & Communications Technology Promotion, Research Project Title: WiseKB: Big Data Based Self-Evolving Knowledge Base and Reasoning Platform, Task ID No.: R0101-15-0054].

### BACKGROUND ART

A knowledge base that stores knowledge data and provides stored knowledge data may be implemented in various ways. For example, a knowledge base with respect to a certain domain may be established by an Expert Group of the domain or may be established by extracting knowledge from data. In the former case, knowledge data of high accuracy may be provided, but a size of a constructible knowledge base may be restricted. Accordingly, a method of collecting data and establishing a knowledge base from collected data has been considered.

### DETAILED DESCRIPTION OF THE INVENTIVE CONCEPT

### Technical Problem

One or more embodiments of the present invention relate to a system and method for verifying and correcting knowledge base by correcting incomplete knowledge data through crowd sourcing.

### Technical Solution

According to an embodiment of the present invention, there is provided a knowledge base correction system including: a question generator configured to detect incomplete knowledge data of a knowledge base and to generate a question, an answer to which is used to correct the incomplete knowledge data; a user information storage configured to store level information about a plurality of users; and a question selector configured to determine a number of questions and questions to be assigned to each of the plurality of users, based on the level information of the plurality of users.

According to an exemplary embodiment, the question generator may include an error detector configured to detect knowledge data including a first instance that has a property, in which a plurality of values are written, knowledge data including a second instance, in which a written value does not match with a format of a property, or knowledge data including a second instance having a property, a value of which is omitted.

According to an exemplary embodiment, the question generator may further include a question generator configured to generate an objective question including the first instance, properties on which the plurality of values are mapped, and the plurality of values, a subjective question including the second instance and the property, the written value of which does not match with the format, or a subjective question including the third instance and the property, the value of which is omitted.

According to an exemplary embodiment, the knowledge base correction system may further include a candidate knowledge generator configured to generate candidate knowledge data including a question selected by the question selector and at least one answer to the question.

According to an exemplary embodiment, the knowledge base correction system may further include a candidate knowledge verifier configured to verify the candidate knowledge data based on at least one piece of candidate knowledge data corresponding to an identical question and to correct the knowledge data stored in the knowledge base based on the candidate knowledge data of which verification has succeeded.

According to an exemplary embodiment, the candidate knowledge verifier may be configured to provide a question corresponding to the candidate knowledge data of which verification by the question selector has failed, and the question selector may be configured to determine that the question provided by the candidate knowledge verifier is to be assigned to a plurality of users that are different from the plurality of users who have received the question earlier.

According to an exemplary embodiment, the knowledge base correction system may further include a user level analyzer configured to update the level information of the users stored in the user information storage, based on the candidate knowledge data and a verification result of the candidate knowledge data in the candidate knowledge verifier.

According to an exemplary embodiment, the knowledge base correction system may further include: a user interface configured to transmit the question and receive the answer.

According to an exemplary embodiment, the knowledge base correction system may further include a reward interface configured to provide a reward system with the level information of the plurality of users stored in the user information storage.

### Advantageous Effects

A system and method for verifying and correcting a knowledge base according to the present invention provides a unit for correcting incomplete knowledge data in a vast knowledge base to improve the reliability and utilization level of the knowledge base.

Also, the system and method for verifying and correcting the knowledge base according to the present invention may improve the reliability of correcting the incomplete knowledge data through crowd sourcing.

Also, the system and method for verifying and correcting the knowledge base according to the present invention provides a unit for benefiting a user who has participated in correcting the incomplete knowledge data, so that the knowledge base may continuously provide high quality service.

### DESCRIPTION OF THE DRAWINGS

FIG. 1 is a block diagram of a knowledge base correction system according to an exemplary embodiment;

FIG. 2 is a block diagram of an example of a question generator in FIG. 1 according to the exemplary embodiment;

FIG. 3 shows an example of incomplete knowledge data;

FIG. 4 is a diagram illustrating an operation of a candidate knowledge verifier in FIG. 1 according to the exemplary embodiment;

FIG. 5 is a block diagram of a knowledge base correction system according to an exemplary embodiment;

FIG. 6 is a flowchart of a knowledge base correction method according to an exemplary embodiment; and

FIG. 7 is a flowchart of a knowledge base correction method according to an exemplary embodiment.

### MODE OF THE INVENTION

Hereinafter, one or more embodiments of the present invention will be described in detail with reference to accompanying drawings. The embodiments are provided so that this disclosure will be thorough and complete, and will fully convey the concept of the present invention to those skilled in the art. As the present invention allows for various changes and numerous embodiments, particular embodiments will be illustrated in the drawings and described in detail in the written description. However, this is not intended to limit the present invention to particular modes of practice, and it is to be appreciated that all modifications, equivalents, and/or alternatives that do not depart from the spirit and technical scope are encompassed in the present invention. When describing the drawings, like reference numerals in the drawings denote like elements. In the accompanying drawings, sizes of components in the drawings may be exaggerated or reduced for clearing the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms (including technical and scientific terms) used herein have the same meanings as commonly understood by one of ordinary skill in the art to which this invention belongs. Such terms as those defined in a generally used dictionary are to be interpreted to have the meanings equal to the contextual meanings in the relevant field of art, and are not to be interpreted to have ideal or excessively formal meanings unless clearly defined in the present invention.

Hereinafter, a component represented or described as one block may be a hardware block or a software block. For example, each of the components may be an independent hardware block for exchanging signals with another hardware block, or a software block executed in one processor.

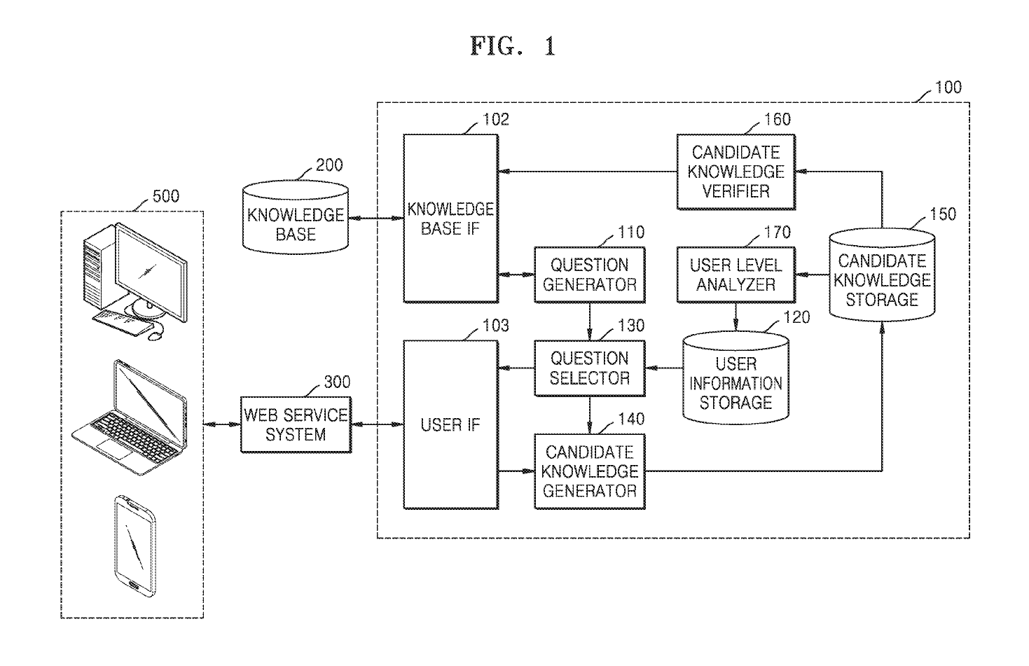

FIG. 1 is a block diagram of a knowledge base correction system 100 according to an exemplary embodiment.

A knowledge base established by collecting data and extracting knowledge from collected data has a vast scale, but may include incomplete knowledge data, e.g., errors or insufficient knowledge data. For example, data that is the basis for establishing of the knowledge base may include structured data such as a database (e.g., Wikipedia), comma-separated values (CSV) files, etc., or unstructured data such as news, blogs, social networking sites, document files, etc. In a case where the knowledge base is established from the structured data, the knowledge base may be easily established according to mapping rules set by an expert who understands the schema of the knowledge base. On the other hand, in a case where the knowledge base is established from the unstructured data, an operation of extracting and structuring knowledge from the unstructured data by using a natural language processing technique including lexical analyzing, syntax analyzing, etc. is necessary, and accordingly, the knowledge base may include errors due to limitations in the natural language processing technique, reliability in the unstructured data, etc.

In order to correct incomplete knowledge data included in the knowledge base established from an enormous amount of unstructured data collected via the Internet, etc., it may be impossible for minority of experts to detect and correct incomplete knowledge data included in the knowledge base. Correction of the incomplete knowledge data included in the knowledge base is an essential operation for improving the reliability of the knowledge base and improving the utilization of the knowledge base, and the present invention provides a system and method for detecting incomplete knowledge data included in knowledge base and easily correcting the incomplete knowledge data through crowd sourcing.

Referring to FIG. 1, the knowledge base correction system 100 may communicate with a knowledge base 200 and a Web service system 300, and user terminals 500 may communicate with the Web service system 300. The knowledge base correction system 100, the knowledge base 200, the Web service system 300, and the user terminals 500 may communicate with one another by accessing a network, such as local area network (LAN) and wide area network (WAN), or may perform two-party communication via one-to-one communication through a dedicated channel. As shown in FIG. 1, the knowledge base correction system 100 may include a knowledge base interface 102, a user interface 103, a question generator 110, a question selector 120, a user information storage 130, a candidate knowledge generator 140, a candidate knowledge storage 150, a candidate knowledge verifier 160, and a user level analyzer 170.

The knowledge base interface 102 may provide other elements included in the knowledge base correction system 100 with an interface for accessing the knowledge base 200. For example, as will be described later, the question generator 110 and the candidate knowledge verifier 160 may access the knowledge base 200 via the knowledge base interface 102 so as to receive the knowledge data stored in the knowledge base 200 or transmit corrected knowledge data to the knowledge base 200.

Similarly, the user interface 103 may provide other elements included in the knowledge base correction system 100 with an interface for accessing the web service system 300. For example, as will be described later, the question selector 120 and the candidate knowledge generator 140 may access the Web service system 300 via the user interface 103 so as to transmit questions or to receive answers to the questions.

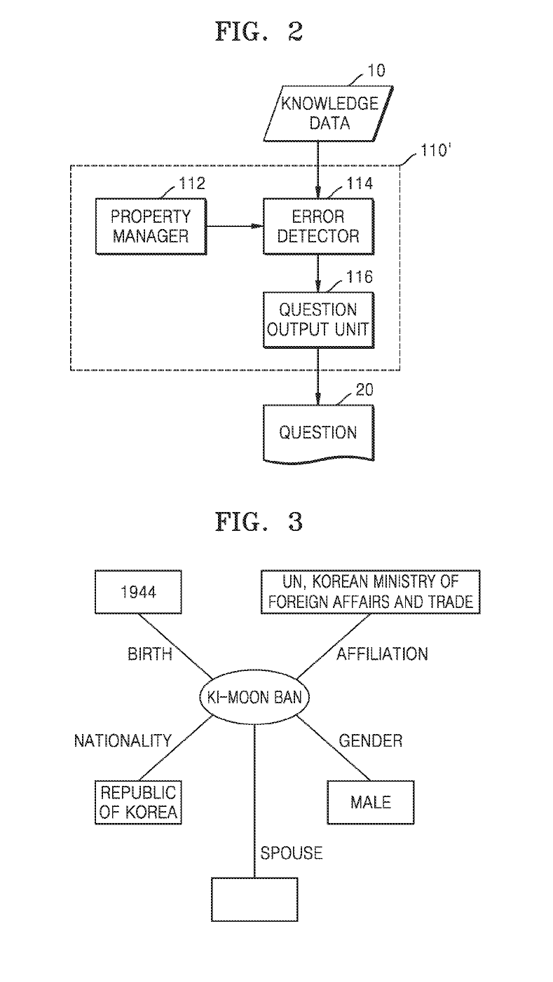

The question generator 110 may detect incomplete knowledge data, knowledge data including errors, or insufficient knowledge data from the knowledge base 200, and may generate a question, an answer to which may correct the incomplete knowledge data. For example, the question generator 110 may detect contradicting knowledge or knowledge omitted from the knowledge base, and may generate a question having an answer for correcting the detected knowledge. Some of generated questions may be provided to a plurality of users. The question generator 110 will be described in more detail later with reference to FIGS. 2 and 3.

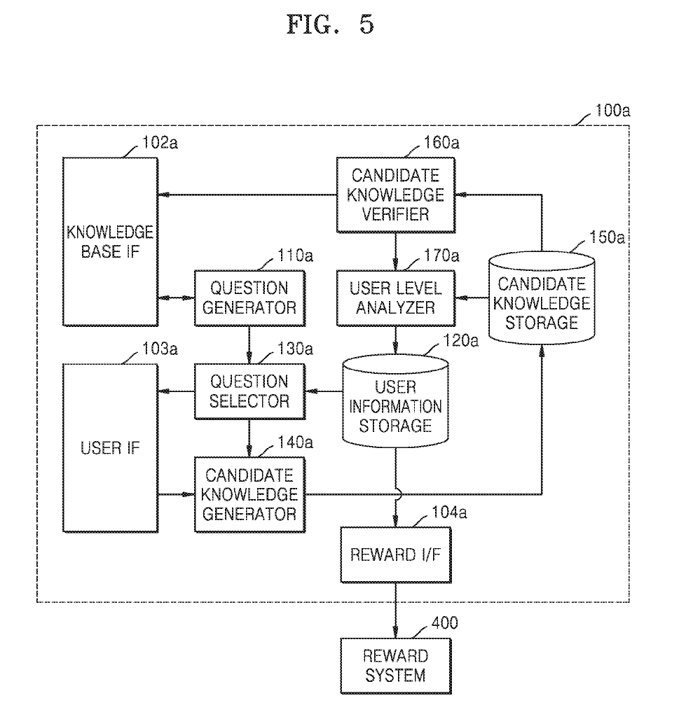

The user information storage 120 may store levels of a plurality of users. A level of a user (or a user level) may correspond to evaluation of the user according to an answering attitude of the user (e.g., the number of times of answering, a period, etc.) and reliability of the answer. As will be described later, the user level may be used as a criterion for determining users to which questions generated by the question generator 110 are respectively to be assigned. Also, the user information storage 120 may store identification information of users, and the identification information of the users may be used to synchronize the users with users of an external system (e.g., a reward system 400 shown in FIG. 5) such as the Web service system 300.

The question selector 130 may determine questions to be assigned to each of the users and the number of questions, based on level information of the users, that is, user level information. For example, the question selector 130 may assign relatively many questions to a user having a high user level and may assign questions having high difficulty (e.g., subjective question) to a user having a high user level. Accordingly, problems that may occur when the questions are provided to the users without taking into account the user level, for example, degradation in reliability of the answers, delay in answering, etc. may be prevented. The question selector 130 may output at least one question selected through the user interface 103 out of the knowledge base correction system, and at this time, information of the user to which the question is assigned may be also output.

The candidate knowledge generator 140 may generate candidate knowledge data including at least one question selected by the question selector 130 and an answer to the at least one question. In one embodiment, the candidate knowledge generator 140 may receive the selected question from the question selector 130, and may receive the answer to the selected question through the user interface 103. In another embodiment, the candidate knowledge generator 140 may receive both the question and the answer to the question via the user interface 103. The candidate knowledge data is possible to be the knowledge data stored in the knowledge base 200, and as will be described later, may be used to correct the knowledge data in the knowledge base 200 provided that the candidate knowledge verifier 160 has succeeded in verifying the candidate knowledge data.

The candidate knowledge storage 150 may store the candidate knowledge data generated by the candidate knowledge generator 140. As described above, the candidate knowledge generator 140 may generate the candidate knowledge data including the question and the answer to the question, and the candidate knowledge storage 150 may store the candidate knowledge data generated by the candidate knowledge generator 140 with respect to a plurality of questions and answers. As shown in FIG. 1, the candidate knowledge storage 150 may receive the candidate knowledge data from the candidate knowledge generator 140, and may provide the candidate knowledge data to the candidate knowledge verifier 160 and the user level analyzer 170.

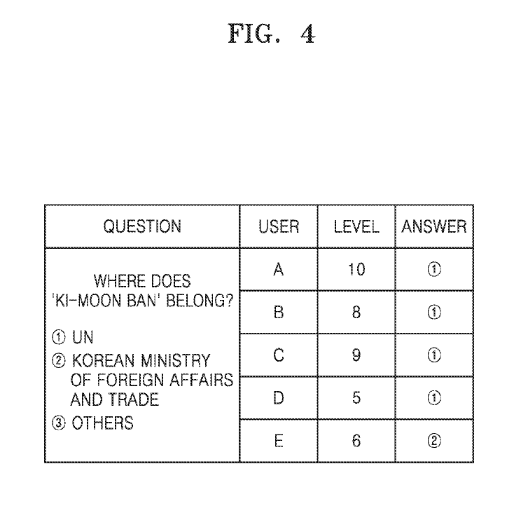

The candidate knowledge verifier 160 may verify the candidate knowledge data based on at least one piece of candidate knowledge data corresponding to the same questions. The candidate knowledge verifier 160 may correct the knowledge data stored in the knowledge base via the knowledge base interface 102, based on the candidate knowledge data that has been verified. As will be described later with reference to FIG. 4, the candidate knowledge verifier 160 may verify the candidate knowledge data by evaluating answers provided from a plurality of users to the same question. The candidate knowledge verifier 160 will be described in detail later with reference to FIG. 4.

The user level analyzer 170 may update user level information stored in the user information storage 120, based on the candidate knowledge data and the verification result regarding the candidate knowledge data performed by the candidate knowledge verifier 160. For example, the user level analyzer 170 may update the user level information stored in the user information storage 120 based on the verification result regarding the candidate knowledge data performed by the candidate knowledge verifier 160, so that the level of the user who provides the answer that has been verified may be increased. In addition, the user level analyzer 170 may update the user level information by a constant period (e.g., one week, one month, etc.) That is, based on the number of answers provided by the user within a predetermined period, the user level analyzer 170 may reduce the user level if the number of answers is less than a reference set in advance and may increase the user level otherwise.

In the example of FIG. 1, the user information storage 120 and the candidate knowledge storage 150 may be accessed by the elements of the knowledge base correction system 100. In one embodiment, the user information storage 120 and the candidate knowledge storage 150 may respectively include adaptors processing accesses from outside, and the elements of the knowledge base correction system 100 may store data in the user information storage 120 and the candidate knowledge storage 150 or may read stored data from the user information storage 120 and the candidate knowledge storage 150 via the adaptors. In another embodiment, the elements accessing the user information storage 120 and the candidate knowledge storage 150 may each include the adaptor for accessing the user information storage 120 and the candidate knowledge storage 150.

Although FIG. 1 shows an example in which the knowledge base correction system 100 accesses the knowledge base 200, the knowledge base correction system 100 may include the knowledge base 200 according to an exemplary embodiment, and in this case, the knowledge base correction system 100 may execute the function of the knowledge base, that is, providing of the knowledge data. Also, FIG. 1 shows an example in which the knowledge base correction system 100 communicates with the user terminals 500 via the Web service system 300, but the knowledge base correction system 100 according to the exemplary embodiment may directly communicate with the user terminals 500 via the user interface 103. In addition, the knowledge base correction system 100 may communicate with a plurality of knowledge bases and a plurality of Web service systems.

FIG. 2 is a block diagram showing an example (110′) of the question generator 110 shown in FIG. 1 according to the exemplary embodiment, and FIG. 3 is a diagram of an example of incomplete knowledge data. As described above with reference to FIG. 1, the question generator 110′ may detect incomplete knowledge data from the knowledge base 200 of FIG. 1, and may generate a question, an answer to which may correct the incomplete knowledge data.

Referring to FIG. 2, the question generator 110′ may receive knowledge data 10. For example, the question generator 110′ may scan the knowledge data stored in the knowledge base 200 in order to detect incomplete knowledge data from the knowledge base 200, and may receive the knowledge data 10. The knowledge data stored in the knowledge base 200 of FIG. 1 may include ontology data, for example, data having a format such as resource description framework (RDF) and instances generated by RDF schema. Referring to FIG. 3, as an instance, a category such as a person, for example, ‘Ki-moon Ban’, may have a plurality of properties. For example, as shown in FIG. 3, the category ‘person’ to which ‘Ki-moon Ban’ belongs may have properties such as ‘birth’, ‘nationality’, ‘spouse’, ‘gender’, ‘affiliation’, etc., and the instance ‘Ki-moon Ban’ may have exclusive values with respect to the properties (e.g., 1994, Republic of Korea, etc.)

Referring to FIG. 2, the question generator 110′ may include a property manager 112, an error detector 114, and a question output unit 116. The property manager 112 may store information about the properties according to categories (e.g., person, organization, geography, event, etc.) constituting the knowledge data, and may provide the error detector 114 with the information about the properties. For example, referring to FIG. 3, the property manager 112 may store ‘birth’, ‘nationality’, ‘spouse’, ‘gender’, and ‘affiliation’ as the properties of a person, and may provide the error detector 114 with the properties. Also, the information about the properties provided by the property manager 112 may include information about formats that values of the properties have, e.g., numbers, URL, text, etc.

The error detector 114 may detect incomplete knowledge data, e.g., knowledge data including errors or insufficient knowledge data. That is, based on the property information provided by the property manager 112, it may be determined whether the knowledge data 10 is incomplete knowledge data. For example, the error detector 114 may detect the knowledge data including an instance having a property, in which a plurality of values are written. As shown in FIG. 3, ‘Ki-moon Ban’, that is, an instance of the knowledge stored in the knowledge base 200, may have two or more values (‘UN’ and ‘Korean Ministry of Foreign Affairs and Trade’) as the values of the property ‘affiliation’, and the error detector 114 may detect the knowledge data including ‘Ki-moon Ban-Affiliation-UN, Korean Ministry of Foreign Affairs and Trade’. As another example, the error detector 114 may determine that the knowledge data includes errors in a case where the property (e.g., ‘birth’) included in the knowledge data has a value of a different format (e.g., English letters) from the format of the property (e.g., number of four digits).

In addition, the error detector 114 may detect the insufficient knowledge data, that is, the knowledge data including an instance having the property, a value of which is omitted. As shown in FIG. 3, ‘Ki-moon Ban’ as an instance of the knowledge stored in the knowledge base 200 of FIG. 1 may have an omitted value of the property ‘spouse’, and the error detector 114 may detect the insufficient knowledge data including ‘Ki-moon Ban-spouse-empty’.

The question output unit 116 may generate a question 20 based on the knowledge data detected by the error detector 114. For example, the question output unit 116 may generate an objective question including the instance, the property in which a plurality of values are written, and a plurality of values, in a case where the knowledge data includes the instance having the property, in which the plurality of values are written. Also, the question output unit 116 may generate a subjective question including the instance, and the property, the value of which is omitted, in a case where the knowledge data includes the instance having the property, the value of which is omitted. Referring to FIG. 3, the question output unit 116 may generate a question “Where does Ki-moon Ban belong? \textcircled{1} UN \textcircled{2} Korean Ministry of Foreign Affairs and Trade \textcircled{3} others” as shown in FIG. 4, with respect to the knowledge data including ‘Ki-moon Ban—affiliation—UN, Korean Ministry of Foreign Affairs and Trade’. Also, the question output unit 116 may generate a question “Who is Ki-moon Ban's spouse?” with respect to the knowledge data including ‘Ki-moon Ban-spouse-empty’. As described above with reference to FIG. 1, the question generated by the question output unit 116 may be assigned to a user by the question selector 120 of FIG. 1.

FIG. 4 is a diagram illustrating an operation of the candidate knowledge verifier 160 in FIG. 1 according to the exemplary embodiment. In detail, FIG. 4 shows an example of the candidate knowledge data that the candidate knowledge verifier 160 receives from the candidate knowledge storage 150. As described above with reference to FIG. 1, the candidate knowledge verifier 160 may verify the candidate knowledge data including a question and an answer, and may correct the knowledge data stored in the knowledge base 200 based on the candidate knowledge data that has been verified.

Referring to FIGS. 3 and 4, in order to correct the knowledge data including ‘Ki-moon Ban-affiliation-UN, Korean Ministry of Foreign Affairs and Trade’, the question “Where does Ki-moon Ban belong?” is generated by the question generator 110 of FIG. 1, and the question selector 120 assigns the question to five users (A, B, C, D, and E), and the candidate knowledge generator 140 may generate the candidate knowledge data as shown in FIG. 4 by receiving answers from the five users A, B, C, D, and E. In the example of FIG. 4, the candidate knowledge data may include information about user and the user level.

The candidate knowledge verifier 160 may verify the candidate knowledge data based on the number of users providing an identical answer to a common question. That is, in a case where the number of users providing the identical answer is equal to or greater than a predetermined ratio, the candidate knowledge verifier 160 may determine that the verification of the candidate knowledge data including the answer has succeeded. For example, in the example of FIG. 4, since the ratio of the users answering \textcircled{1} (A, B, C, and D) between the total number of users who answered the question (4/5) exceeds a predetermined ratio (2/3), the candidate knowledge verifier 160 may correct the knowledge data including ‘Ki-moon Ban-affiliation-UN, Korean Ministry of Foreign Affairs and Trade’ into the knowledge data including ‘Ki-moon Ban-affiliation-UN’.

Also, the candidate knowledge verifier 160 may verify the candidate knowledge data based on the user level information, as well as the number of users providing the identical answer. That is, a weighted value may be applied to the answer of the user having a high level to improve the reliability in the verification of the candidate knowledge data. For example, in the example of FIG. 4, the candidate knowledge verifier 160 may calculate a sum of the levels of the users answering \textcircled{1} (A, B, C, and D) and a sum of the levels of the users answering \textcircled{2}, and when a ratio of the greatest sums exceeds a predetermined ratio, the candidate knowledge verifier 160 may determine that the verification of the candidate knowledge data including the answer corresponding to the greatest sum of the levels has succeeded.

When the verification of the candidate knowledge data has failed, for example, when the number of users providing the identical answer is less than the predetermined ratio or the ratio of the largest sum of levels is less than the predetermined ratio, the candidate knowledge verifier 160 may determine that the verification of the candidate knowledge data has failed. Information about the candidate knowledge data, the verification of which is determined as failure by the candidate knowledge verifier 160, may be provided to the question selector 130. The question selector 130 may determine to align the question corresponding to the candidate knowledge data that has failed to be verified to a plurality of other users than the above users. Accordingly, the candidate knowledge data that has failed to be verified may be verified later by the candidate knowledge verifier 160 based on answers provided by the other users than the above users.

FIG. 5 is a block diagram of a knowledge base correction system 100a according to an exemplary embodiment. When comparing with the knowledge base correction system 100 of FIG. 1, the knowledge base correction system 100a of FIG. 5 may further include a reward interface 104a for communicating with a reward system 400. Hereinafter, the elements described above with reference to FIG. 1 will be omitted.

The reward interface 104a may provide an interface for the reward system 400 at an external portion of the knowledge base correction system 100a to access a user information storage 120a. For example, as will be described later, the user level information stored in the user information storage 120a may be utilized by the reward system 400, and the reward interface 104a may provide the interface for providing a plurality of reward systems including the reward system 400 with the user level information.

The reward system 400 may provide the users with reward based on the user level information of the knowledge base correction system 100a (or the user information storage 120). For example, the reward system 400 may provide the user who answers the question with the reward corresponding to the level of the user, or may regularly provide the user with the reward corresponding to the user level by checking the user levels regularly. The reward provided by the reward system 400 may be useful for the users, and may include, but not limited to, coupons, money, points that may be used in affiliated stores, etc.

The user who answers the question provided from the knowledge base correction system 100a may obtain reward, which may encourage the user to answer the questions. As described above with reference to FIG. 1, the user level information stored in the user information storage 120a may be updated by a user level analyzer 170a, and the user level information is determined based on the answering attitude of the user and reliability in the answer. Thus, verification of the knowledge base 200 of high efficiency and reliability may be accomplished.

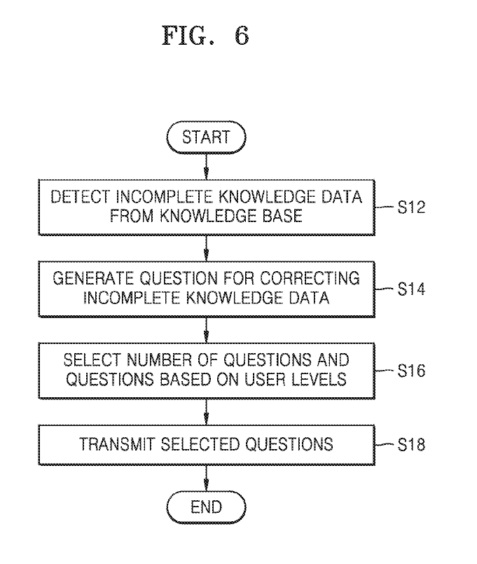

FIG. 6 is a flowchart illustrating a knowledge base correction method according to an exemplary embodiment. In detail, FIG. 6 is a flowchart illustrating a method of generating a question provided to the user in order to correct the knowledge base 200 of FIG. 1. Hereinafter, FIG. 6 will be described with reference to FIGS. 1 and 2. As shown in FIG. 6, the method of correcting the knowledge base 200 may include a plurality of steps S12, S14, S16, and S18.

In operation S12, an operation of detecting incomplete knowledge data from the knowledge base 200 may be performed. For example, the error detector 114 included in the question generator 110′ of FIG. 2 may determine whether the knowledge data 10 is incomplete knowledge data, for example, knowledge data including errors or insufficient knowledge data, based on property information provided by the property manager 112, and may detect the incomplete knowledge data.

In operation S14, an operation of generating a question for correcting the incomplete knowledge data may be performed. For example, the question output unit 116 included in the question generator 110′ of FIG. 2 may generate a question from the incomplete knowledge data detected by the error detector 114. As described above, the generated question may be an objective question including a plurality of selectable answers, or a subjective question.

In operation S16, an operation of setting the number of questions and selecting questions based on user levels may be performed. For example, the question selector 120 of FIG. 1 may determine the number of questions to be aligned to a user and the question to be aligned to the user from among the plurality of questions generated by the question selector 110, based on the user level information stored in the user information storage 130. Similarly, the question selector 120 may determine a plurality of users, to which the questions generated by the question generator 110 are to be aligned, based on the user level information stored in the user information storage 130.

In operation S18, an operation of transmitting the selected questions may be performed. For example, the questions selected by the question selector 120 of FIG. 1 may be transmitted with user information to the Web service system 300 via the user interface 103, and the Web service system 300 may transmit the questions to one or more selected according to the user information from among the user terminals 500.

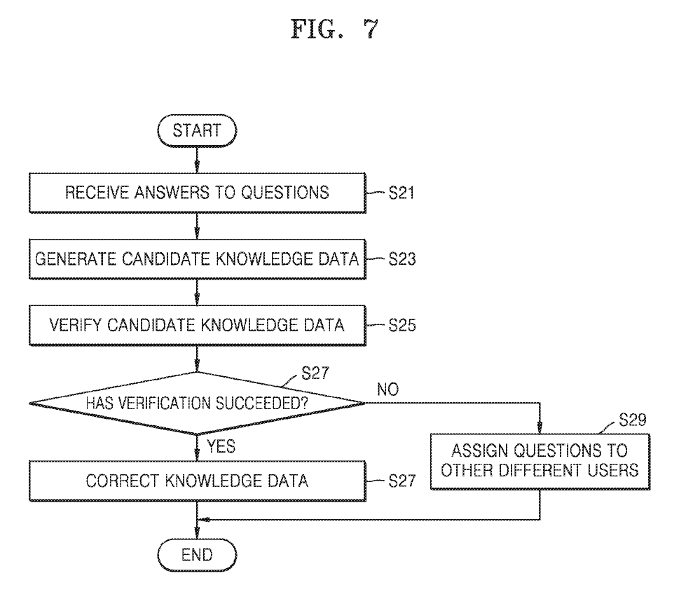

FIG. 7 is a flowchart illustrating a knowledge base correction method according to an exemplary embodiment. In detail, FIG. 7 is a flowchart illustrating a method of correcting the knowledge base 200 by evaluating answers transmitted from the users, and the method may be performed next to the method illustrated in the flowchart of FIG. 6. Hereinafter, FIG. 7 will be described with reference to FIG. 1. As shown in FIG. 7, the method of correcting the knowledge base 200 may include a plurality of steps S21, S23, S25, S27, and S29.

In operation S21, an operation of receiving answers to the questions may be performed. As described above with reference to FIGS. 1 and 6, the question generated to correct the incomplete knowledge data may be provided to the user (e.g., via the Web service system 300), and the user may transmit an answer to the question. For example, the Web service system 300 of FIG. 1 may receive answers from the user terminals 500, and may transmit the received answers to the knowledge base correction system 100. The candidate knowledge generator 140 of the knowledge base correction system 100 may receive the answers from the user interface 103.

In operation S23, an operation of generating the candidate knowledge data may be performed. For example, the candidate knowledge generator 140 of FIG. 1 may generate the candidate knowledge data including a question, an answer of the user to the question, and user information. Also, in one embodiment, the candidate knowledge generator 140 may generate candidate knowledge data further including level information of the user answering the question. The candidate knowledge data generated by the candidate knowledge generator 140 may be stored in the candidate knowledge storage 150.

In operation S25, an operation of verifying the candidate knowledge data may be performed. For example, the candidate knowledge verifier 160 of FIG. 1 may receive the candidate knowledge data including a plurality of answers to an identical question by accessing the candidate knowledge storage 150 storing the candidate knowledge data, and may verify the candidate knowledge data. As described above with reference to FIG. 4, the candidate knowledge verifier 160 may verify the candidate knowledge data based on the number of users providing an identical answer, or based on levels of the users providing the identical answer.

When the verification of the candidate knowledge data has succeeded, an operation of correcting the knowledge data may be performed in operation S27. For example, the candidate knowledge verifier 160 of FIG. 1 may correct the knowledge data including errors because two or more values are written with respect to one property, so that the knowledge data may include only one value corresponding to the verified answer. Also, with respect to the insufficient knowledge data having the property, the value of which is omitted, the knowledge data may be corrected to have a value corresponding to the verified answer for the property.

When the verification of the knowledge data has failed, an operation of aligning the question to other users than the above users may be performed in operation S29. For example, the question selector 120 of FIG. 1 may receive the candidate knowledge data that has failed to be verified (or the question corresponding thereto) from the candidate knowledge verifier 160, and the question selector 120 may align the question to a plurality of users, to which the question has not been aligned. The aligned question may be provided to new users, and answers from the new users may be used to re-verify the candidate knowledge data.

Although a few embodiments of the present invention have been shown and described, it would be appreciated by those skilled in the art that changes may be made to these embodiments without departing from the principle and spirit of the invention, the scope of which is defined in the claims and their equivalents.

1. A knowledge base correction system comprising:
a question generator configured to detect incomplete knowledge data of a knowledge base and to generate a question, an answer to which is used to correct the incomplete knowledge data;
a user information storage configured to store level information about a plurality of users; and
a question selector configured to determine a number of questions and questions to be assigned to each of the plurality of users, based on the level information of the plurality of users.

2. The knowledge base correction system of claim 1, wherein the question generator comprises an error detector configured to detect knowledge data including a first instance that has a property, in which a plurality of values are written, knowledge data including a second instance, in which a written value does not match with a format of a property, or knowledge data including a second instance having a property, a value of which is omitted.

3. The knowledge base correction system of claim 2, wherein the question generator further comprises a question generator configured to generate an objective question including the first instance, properties on which the plurality of values are mapped, and the plurality of values, a subjective question including the second instance and the property, the written value of which does not match with the format, or a subjective question including the third instance and the property, the value of which is omitted.

4. The knowledge base correction system of claim 1, further comprising a candidate knowledge generator configured to generate candidate knowledge data including a question selected by the question selector and at least one answer to the question.

5. The knowledge base correction system of claim 4, further comprising a candidate knowledge verifier configured to verify the candidate knowledge data based on at least one piece of candidate knowledge data corresponding to an identical question and to correct the knowledge data stored in the knowledge base based on the candidate knowledge data of which verification has succeeded.

6. The knowledge base correction system of claim 5, wherein the candidate knowledge verifier is configured to provide a question corresponding to the candidate knowledge data of which verification by the question selector has failed, and the question selector is configured to determine that the question provided by the candidate knowledge verifier is to be assigned to a plurality of users that are different from the plurality of users who have received the question earlier.

7. The knowledge base correction system of claim 5, further comprising a user level analyzer configured to update the level information of the users stored in the user information storage, based on the candidate knowledge data and a verification result of the candidate knowledge data in the candidate knowledge verifier.

8. The knowledge base correction system of claim 1, further comprising:
a user interface configured to transmit the question and receive the answer.

9. The knowledge base correction system of claim 1, further comprising:
a reward interface configured to provide a reward system with the level information of the plurality of users stored in the user information stor
